(19) United States
(12) Patent Application Publication
(10) Pub. No.: US 2022/0360985 A1
(43) Pub. Date: Nov. 10, 2022

(54) UE REJECTION HANDLING WHEN ONBOARDING A NETWORK BASED ON DEFAULT UE CREDENTIALS

(71) Applicant: MEDIATEK INC., Hsinchu (TW)

(72) Inventor: Yuan-Chieh LIN, Hsinchu (TW)

(73) Assignee: MEDIATEK INC., Hsinchu (TW)

(21) Appl. No.: 17/716,553

(22) Filed: Apr. 8, 2022

Related U.S. Application Data
(60) Provisional application No. 63/185,401, filed on May 7, 2021.

(51) Int. Cl. H04W 12/06; H04W 48/18; H04W 12/08

(52) U.S. Cl. CPC H04W 12/06; H04W 48/18; H04W 12/08

(57) ABSTRACT

A method of UE onboarding services can include receiving a first reject message at a UE from a first wireless communication network during a first onboarding process of the UE based on a set of default UE credentials stored in the UE. An identity of the first wireless communication network can be added to a forbidden network list for onboarding services. The UE can perform a network selection process, based on the forbidden network list including the identity of the first wireless communication network, to select a second wireless communication network for a second onboarding process of the UE. The first wireless communication network on the forbidden network list is excluded from available candidate wireless communication networks that support onboarding services. The same set of default UE credentials stored in the UE are used for the second onboarding process of the UE.

### INCORPORATION BY REFERENCE

This present application claims the benefit of U.S. Provisional Application No. 63/185,401, “AUTHENTICATION REJECT handling for SNPN onboarding registration” filed on May 7, 2021, which is incorporated herein by reference in its entirety.

### TECHNICAL FIELD

The present disclosure relates to wireless communications. Some embodiments relate to onboarding services of a wireless communication network.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

A non-public network (NPN) is intended for the sole use of a private entity such as an enterprise. NPNs can be deployed as a stand-alone NPN (SNPN) that is independent to a public network (such as a public land mobile network (PLMN)). Or, NPNs can share resources (such as a network slice) of a public network.

### SUMMARY

Aspects of the disclosure provide a method of user equipment (UE) onboarding services. The method can include receiving a first reject message at a UE from a first wireless communication network that supports onboarding services during a first onboarding process of the UE towards the first wireless communication network based on a set of default UE credentials stored in the UE. In response to the first reject message being received, an identity of the first wireless communication network can be added to a forbidden network list for onboarding services. The UE can perform a network selection process, based on the forbidden network list including the identity of the first wireless communication network, to select a second wireless communication network for a second onboarding process of the UE among available candidate wireless communication networks that support onboarding services. The first wireless communication network on the forbidden network list is excluded from the available candidate wireless communication networks that support onboarding services. The same set of default UE credentials stored in the UE are used for the second onboarding process of the UE towards the second wireless communication network.

In an embodiment, the first wireless communication network and the second wireless communication network are each a stand-alone non-public network (SNPN), and the forbidden network list for onboarding services is a permanently forbidden SNPN list for onboarding services. In an embodiment, the first reject message is a non-access-stratum (NAS) authentication reject message containing an extensible authentication protocol (EAP) failure message.

In an embodiment, the first reject message is a NAS authentication reject message. In an embodiment, the first reject message is a NAS registration reject message containing one of a cause value indicating an illegal UE, a cause value indicating an illegal mobile equipment (ME), or a cause value indicating that fifth-generation system (5GS) services are not allowed.

In an embodiment, the first reject message is a NAS service reject message containing one of a cause value indicating an illegal UE, a cause value indicating an illegal ME, or a cause value indicating that 5GS services are not allowed.

In an embodiment, the first reject message is successfully integrity checked by a NAS of the UE.

In an embodiment, the step of the adding can include, in response to the first reject message being received without integrity protection and a network-specific attempt counter for the first wireless communication network that is an SNPN having a value equal to a maximum value, adding the identity of the first wireless communication network to the forbidden network list for onboarding services.

In an embodiment, the method can further include, in response to a second reject message being received without integrity protection or failing integrity protection check before the first reject message being received without integrity protection or failing integrity protection check and the network-specific attempt counter for the first wireless communication network that is an SNPN having a value less than the maximum value, incrementing the network-specific attempt counter for the first wireless communication network that is the SNPN.

Aspects of the disclosure further provide an apparatus comprising circuitry. The circuitry can be configured to receive a first reject message at a UE from a first wireless communication network that supports onboarding services during a first onboarding process of the IE towards the first wireless communication network based on a set of default UE credentials stored in the UE. In response to the first reject message being received, an identity of the first wireless communication network can be added to a forbidden network list for onboarding services. The UE can perform a network selection process, based on the forbidden network list including the identity of the first wireless communication network, to select a second wireless communication network for a second onboarding process of the UE among available candidate wireless communication networks that support onboarding services. The first wireless communication network on the forbidden network list is excluded from the available candidate wireless communication networks that support onboarding services. The same set of default UE credentials stored in the UE are used for the second onboarding process of the UE towards the second wireless communication network.

Aspects of the disclosure further provide a non-transitory computer-readable medium storing instructions that, when executed by a processor, cause the process to perform the method of UE onboarding services.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a wireless communication system 100 according to embodiments of the disclosure.

FIG. 2 shows an exemplary user equipment (UE) onboarding process 200 according to an embodiment of the disclosure.

FIG. 3 shows an exemplary apparatus 300 according to embodiments of the disclosure.

### DETAILED DESCRIPTION OF EMBODIMENTS

### I. UE Onboarding Process and Onboarding Services of an Onboarding Network

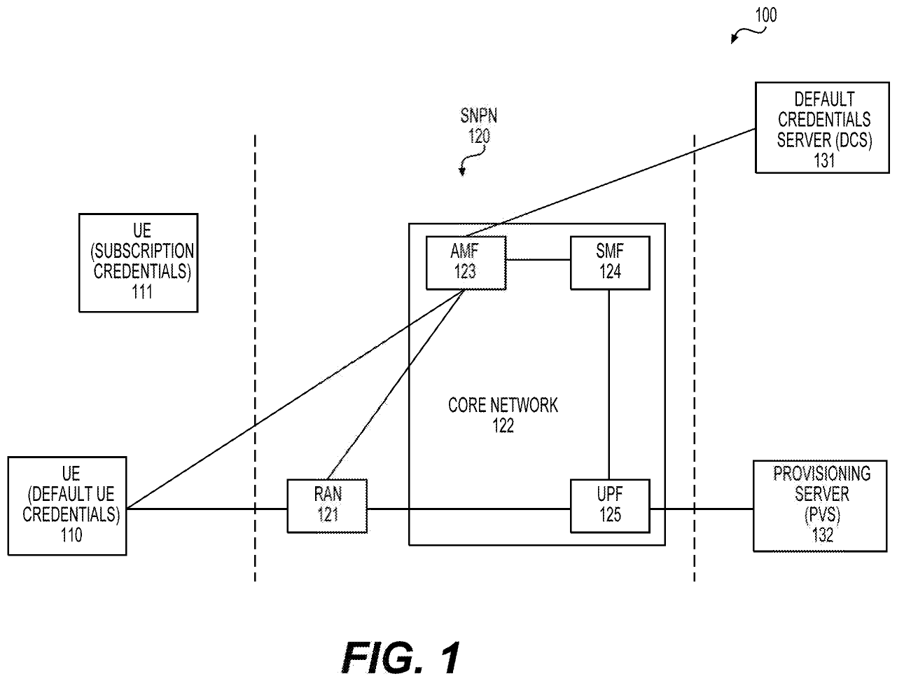

FIG. 1 shows a wireless communication system 100 according to embodiments of the disclosure. The system 100 can be configured to provide onboarding services to a user equipment (UE). By the onboarding services, the UE can be provisioned with configuration data from a remote provisioning server and thus enable the UE to access a desired network using the configuration data. The system 100 can include a UE 110, a stand-alone non-public network (SNPN) 120, a default credentials server (DCS) 131, and a provisioning server (PVS) 132. The SNPN 120 can include a radio access network (RAN) 121 and a core network 122. The core network 122 can include an access and mobility management function (AMF), a session management function (SMF), and a user plane function (UPF). Those elements are coupled together as shown in FIG. 1.

The SNPN 120 can be a non-public network (NPN) deployed for non-public use and independent from any public networks (such as a public land mobile network (PLMN)). The SNPN 120 can be a 5G system as specified by the 3rd Generation Partnership Project (3GPP) 5G standards. Accordingly, the SNPN 120 and elements of the SNPN 120 (such as the RAN 121, AMF 123, SMF 124, and UPF 125) can operate according to functions and procedures defined in the respective 3GPP specifications.

For example, the SNPN 120 can be identified by a combination of a PLMN identifier (ID) and a network identifier (NID). The RAN 121 can broadcast system information including one or more multiple PLMN IDs and a list of NIDs per PLMN ID to indicate which SNPNs the RAN 121 provides access to.

An SNPN-enabled UE 111 can subscribe to the SNPN 120 and be configured (or provisioned) with subscription information of the SNPN. The subscription information can include an ID (PLMN ID and NID) of the subscribed SNPN 120; and a subscription identifier (such as a subscription permanent identifier (SUPI)) and credentials for the subscribed SNPN 120. The credentials in the subscription information are associated with a certain subscribed network (the SNPN 120 in the FIG. 1 example) and can be referred to as subscription credentials. The UE 111 provisioned with the subscription information associated with the SNPN 120 can be referred to as a provisioned UE 111. In an example, the subscription information associated with the SNPN 120 can be an entry on a list of subscriber data stored in the UE 111. The list of subscriber data can include one or multiple entries each corresponding to an SNPN. Each entry includes subscription information corresponding to a specific SNPN.

The provisioned UE 111 can operate in SNPN access mode. The provisioned UE 111 can receive system information broadcast by the RAN 121 and detect the ID of the SNPN 120, for example, when powered on. The provisioned UE 11I can accordingly select the SNPN 120 and initiate a registration or service request process to access the SNPN 120.

In some embodiments, the SNPN 120 can be configured to play a role of an onboarding network and provide onboarding services to the UE 110. The SNPN 120 can onboard the UE 110 for a specific SNPN so that the UE 110 can be provisioned with subscription credentials and other information associated with the specific SNPN. This specific SNPN can be referred to as a subscription owner SNPN (SO-SNPN) of the subscription credentials and other information.

This specific SNPN can be the SNPN 120 providing onboarding services or an SNPN other than the SNPN 120. The SNPN 120 can broadcast through the RAN 121 an onboarding enabled indication that indicates whether onboarding is currently enabled for the SNPN 120. The onboarding enabled indication can be broadcasted per cell, for example, to allow the start of the onboarding procedure only in parts of the SNPN.

For example, the UE 110 can be a smartphone, a computer, a laptop, a vehicle, a drone, or the like. The UE 110 is not initially provisioned with subscription credentials of a desired SNPN. As an example, the desire SNPN is assumed to be the SNPN 120 in the FIG. 1 example. The UE 110 can thus be referred to as an un-provisioned UE with respect to the SNPN 120.

The UE 110 can be configured with default UE credentials (such as a certificate that are signed by a trusted authority, public/private keys, and the like) and a unique UE identifier, for example, at the site of a UE manufacturer when the UE 110 is manufactured. The default UE credentials and the unique UE identifier can be stored in a non-volatile memory (such as an erasable programmable read-only memory (EPROM)) in the UE 110. In an example, the UE 110 can derive an onboarding subscription concealed (SUCI) from an onboarding SUPI. The onboarding SUPI can be unique and derived from the default UE credentials. In an example, the onboarding SUPI is encoded as a network-specific identifier taking the format of a network access identifier (NAI) (such as user@realm) defined by RFC 7542.

Optionally, the UE 110 can be configured with onboarding SNPN selection information. For example, the onboarding SNPN selection information may provide a list of candidate onboarding SNPNs that can be accessed to receive onboarding services.

The UE 110 can be triggered to perform an onboarding process to obtain a set of subscription credentials of the SNPN 120, for example, when the UE is powered on or a user provides an instruction. The default UE credentials can be used for access the onboarding SNPN 120 during the onboarding process. For example, the UE 110 may detect one or more onboarding SNPNs based on broadcast information from the RAN 121. The UE 110 may select the SNPN for onboarding among the detected SNPNs based on the onboarding SNPN selection information, if configured. The UE 110 can subsequently perform an initial registration process to register with the SNPN 120.

In an example, the UE 110 can first establish a radio resource control (RRC) connection towards the RAN 121. The UE 110 can provide an indication in an RRC connection establish message that the RRC connection is for onboarding services. The UE 110 can also indicate the ID of the SNPN 120 (the PLMN ID and NID) to the RAN 121. The indication allows the RAN 121 to select an appropriate AMF that supports the UE onboarding process.

Next, the UE 110 can initiate a non-access-stratum (NAS) registration process by sending a NAS registration request message to the AMF 123. The NAS registration request message may indicate the SUCI derived from the SUPI (that is derived from the default UE credentials). The NAS registration request message may also indicate the registration request is for onboarding. For example, the NAS registration request message can include a fifth-generation system (5GS) registration type information element (IE) that is set to a value of SNPN onboarding services.

In an example, the AMF 123 may locate the DCS 131 based on the SUCI of the UE 110 and start an authentication and authorization process towards the DCS 131. For example, the DCS 131 may be configured with the identifier and the default credentials of the UE 110. Accordingly, the DCS 131 may authenticate the UE 110 based on that information. The DCS 131 may also be configured with authorization information to indicate whether the respective onboarding services are allowed for the UE 110. The DCS 131 may be configured with other information, such as IP address of the PVS 132. If the authentication and authorization process is successful, the AMF 123 can store in a UE context in the AMF 123 an indication that the UE 110 is registered for SNPN onboarding. The AMF 123 may send a NAS registration accept message to inform the UE 110 the registration result. In an example, the DCS 131 can provide means for another entity to authenticate the UE 110 based on the default UE credentials of the UE 110.

Next, after the UE 110 has registered with the SNPN 120, in an example, a protocol data unit (PDU) session can be established between the UE 110 and the PVS 132 via the RAN 121 and the UPF 125. For example, based on an IP address provided by the DCS 131 and related configurations in the AMF 123, the AMF 123 may coordinate the SMF 124 to establish the PDU session through the UPF 125. The PDU session may be restricted to onboarding services (remotely provisioning the UE 110) only.

The PVS 132 can be configured to remotely provision the UE 110 with SNPN credentials for authentication and other information to enable access to the desired SNPN 120. For example, the UE 110 can receive the respective subscription information of the SNPN 120 and store the subscription information into a local non-volatile memory within the UE 110.

After the provisioning, the UE 110 may deregister from the SNPN 120 to end the onboarding process. The UE 110 now becomes a provisioned UE possessing the respective subscription information. The UE 110 can subsequently request a new registration for SNPN services towards the SNPN 120 based on the newly provisioned subscription information, similar to the registration operation performed by the UE 111.

### II. Rejection Handling During an Onboarding Process

During the onboarding process of the UE 110 to obtain the subscription information of the SNPN 120 from the PVS 132, the UE 110 may get rejected in various ways for various reasons. Aspects of the disclosure provide mechanisms to handle these rejections.

In some examples, the UE 110 may receive an authorization reject message during the onboarding process. For example, during the above described SNPN onboarding registration (the registration of the type of the SNPN onboarding registration), the AMF 123 may invoke the DCS 131 to perform the authentication based on the default UE credentials of the UE 110. The authentication process may fail. As a result, an authorization reject message can be transmitted from the AMF 123 to the UE 110.

After the UE 110 is registered with the onboarding SNPN 120, the UE 110 may perform other types of registration processes. For example, the UE 110 may perform a mobility registration update, for example, when the UE 110 moves into a new tracking area. The UE may also perform a periodic registration update due to a predefined time period of inactivity. During these various registration processes, an authentication process based on the default credentials of the UE 110 may take place similarly as in the initial SNPN onboarding registration process. Similarly, if the authentication fails, the UE 110 may receive an authorization reject message.

In addition, after the UE 110 is registered, the UE 110 may perform a service request process, for example, to request establishment of a secure connection to the AMF 123 or to activate a user plane connection for an established PDU session (for example, for the remote provisioning operation). During the service request processes, an authentication process based on the default credentials of the UE 110 may take place similarly as in the initial SNPN onboarding registration process. Similarly, if the authentication fails, the UE 110 may also receive an authorization reject message.

In some examples, different authentication methods may be employed, such as extensible authentication protocol (EAP)-based primary authentication and key agreement procedure or 5G authentication and key agreement (AKA) based primary authentication and key agreement procedure. When EAP-based authentication method is used, an authentication reject message may contain an IE that includes an EAP-failure message.

In some examples, an authentication reject message received during the onboarding process may be integrity protected and can be integrity checked successfully by the NAS at the UE 110. For example, this type of authentication reject message can be received when NAS security contexts have been established and are available at both the UE 110 and the SNPN 120. In some examples, an authentication reject message received during the onboarding process may not be integrity protected or fail integrity protection check. For example, this type of authentication reject message can be received when a respective mutual authentication process between the UE 110 and the SNPN 120 has failed. In some examples, an authentication reject message may be received with integrity protection but the integrity check at the UE 110 has failed.

In some examples, the UE 110 may receive a rejection message (or a reject message) during the onboarding process that indicates a certain reason for the rejection (referred to as a rejection cause). The rejection message can be a registration reject message received during various types of registration processes, such as an SNPN onboarding registration, a mobility registration update, a periodic registration update, and the like. The rejection message can also be a service reject message received during a service request process. The reject message can be other types of reject messages received during other types of request processes performed by the UE 110.

In addition, the rejection message, containing a certain reject cause and received at the UE 110, can be integrity protected or non-integrity protected. If a rejection message is received at the UE 110 after a mutual authentication process between the UE 110 and the SNPN 120 has been completed successfully and NAS security contexts have been established at the UE 110 and the SNPN 120, the rejection message typically is integrity protected. Otherwise, the reject message can be received without integrity protection. A further scenario is that the UE 110 may receive a rejection with integrity protection; however, an integrity check is failed. For example, the rejection message may be originated from an attacker.

In an example, the rejection cause has a cause value (for example, #3) indicating an illegal UE. This cause value can indicate the network (the SNPN 120) refuses service to a UE either because an identity of the UE is not acceptable to the network or because the UE does not pass the authentication check. For example, during a registration or service request process (or other processes) of the UE 110, the authentication and authorization process may fail, because the SUCI of the UE 110 (derived from the default UE credentials) cannot be verified or can be verified but is not authorized to receive the respective onboarding services.

In an example, the reject cause has a cause value (for example, #6) indicating an illegal mobile equipment (ME). For example, during a registration or service request process (or other processes), the AMF 123 may receive a permanent equipment identity (PEI) (such as an international mobile equipment identity (IMEC)) of the UE 110 and perform an equipment identity check against a list of prohibited equipment (for example, stolen equipment). For example, if a record of the UE 110 is found, a reject message indicating an illegal ME can be transmitted from the AMF 123 to the UE 110.

In an example, the reject cause has a cause value (for example, #7) indicating a UE is not allowed to operate 5GS services. For example, during a registration or service request process (or another process), the AMF 123 may determine 5GS services are not allowed for the UE 110 based on a configuration of the SNPN 120 or the DCS 131.

In an example, the reject cause has a cause value (for example, #74) indicating a UE is temporarily not authorized for the SNPN 120 (or the identity of the SNPN 120). For example, the identity of the SNPN 120 is not globally unique. The SNPN 120 may determine the UE 110 is not allowed to operate onboarding services in the SNPN 120. For example, during a registration or service request process (or another process), the AMF 123 may determine onboarding services are not allowed for the UE 110 based on a configuration of the SNPN 120. Or, the DCS 131 may determine the UE 110 is not authorized to use the SNPN 120 to perform an onboarding process temporarily. As the identity of the SNPN 120 is not unique, the SNPN 120 may provide a cause value of #74. The UE 110 can accordingly retry the same SNPN identity after certain conditions are satisfied (for example, after a timer expires or the UE 110 is power cycled; the UE 110 may have travelled to a different area and received the same broadcast SNPN identity).

In an example, the reject cause has a cause value (for example, #75) indicating a UE is permanently not authorized for this SNPN 120 (or the identity of the SNPN 120). For example, the identity of the SNPN 120 can be globally unique. The SNPN 120 may determine that the UE is not allowed to operate onboarding services in the SNPN 120. Or, the DCS 131 may determine the UE 110 is not authorized to use the SNPN 120 to perform an onboarding process. As the identity of the SNPN 120 is globally unique, the UE 110 may not try to access any SNPN with the same identity of the SNPN 120 for onboarding services.

The above are just some examples of cause values contained in a registration reject message, a service reject message, or other types of reject messages during the onboarding process of the UE 110. The UE 110 may receive a reject message containing other types of cause values indicating a failure of the onboarding process through the SNPN 120.

Aspects of the disclosure provide mechanisms for a UE to handle rejections when a reject message and/or a related reject cause, as described above, is received during an onboarding process. The UE 110 performing the onboarding process in the FIG. 1 example is used as an example to explain the mechanisms.

In some embodiments, the UE 110 can consider the default UE credentials of the UE 110 as invalid when a rejection message is received during the onboarding process. The UE 110 may stop trying to access SNPNs for onboarding services based on the invalid default UE credentials. Optionally, the UE 110 may be allowed to use the default UE credentials again when certain conditions are satisfied or certain events take place. Those conditions or events can be, for example, a specific timer expires, the UE 110 is power cycled, or the default UE credentials are updated.

In some embodiments, the UE 110 can consider the default UE credentials as invalid for the current onboarding SNPN 120 when a rejection message is received during the onboarding process. (Or, in other words, the UE 110 can consider the current onboarding SNPN 120 as invalid for the default UE credentials when a rejection message is received during the onboarding process.) The UE 110 may stop trying to access the SNPN 120 for onboarding services based on the invalid default UE credentials. However, the UE 110 may try to access an SNPN other than the SNPN 120. In this way, a failure of a specific SNPN does not prevent the UE 110 from accessing another SNPN using the same set of default credentials to obtain the subscription credentials. In case an attacker deploys a fake base station and broadcasts an indication of supporting onboarding services, it can be avoided that the UE 110 is trapped to an inactive status in response to a fake reject message from the fake base station.

Optionally, the invalid SNPN 120 may become valid when certain conditions are satisfied or certain events take place. Similarly, those conditions or events can be a specific timer expires, the UE 110 is power cycled, the default UE credentials are updated, and the like. For example, the configuration of the SNPN 120 or DCS 131 may have changed. Or, a fake base station has been removed. The UE 110 can use the default UE credentials to access the SNPN 120 again.

In some examples, the UE 110 can maintain one or more forbidden onboarding SNPN lists (or referred to as forbidden SNPN lists for onboarding services). Those lists each can contain identities of onboarding SNPNs for which the default UE credentials of the UE 110 are invalid. For example, when a certain rejection message is received from the SNPN 120, the identity of the onboarding SNPN 120 can be added to one of those forbidden onboarding SNPN lists. Which list is used can depend on what rejection message and/or reject cause has been received and how the UE 110 is configured. For example, when a certain rejection message and/or reject cause is received, the UE 110 can determine which list to use based on the configuration of the UE 110.

The forbidden onboarding SNPN lists can each be associated with a set of conditions that define when entries on a forbidden onboarding SNPN list can be removed. In an example, a permanently forbidden onboarding SNPN list can be maintained and stored in a non-volatile memory and effective after a power cycle. The permanently forbidden onboarding SNPN list can be cleared (entries being removed from the list) when the default UE credentials have been updated. In an example, a temporarily forbidden onboarding SNPN list can be maintained. The temporarily forbidden onboarding SNPN list can be cleared when a timer expires or the UE 110 is power cycled.

In an example, when an authentication reject message is received or a reject cause having a value of #3 (illegal UE), #6 (illegal ME), or #7 (5GS services not allowed), as described in the above examples, the UE 110 can add the identity of the SNPN 120 onto a permanently forbidden onboarding SNPN list. In an example, when a reject cause indicating a network congestion or having a value of #74 (temporarily not authorized for this SNPN), the UE 110 can add the identity of the SNPN 120 onto a temporarily forbidden onboarding SNPN list.

In some embodiments, a counter mechanism is employed in the rejection handling mechanisms disclosed herein.

In an example, for determining the default UE credentials as invalid (the UE 110 does not access for onboarding services using the default UE credentials anymore), an SNPN-specific counter (or referred to as an SNPN-specific attempt counter or network-specific attempt counter) for counting a number of rejections is employed. Before an account of times of receiving rejection messages from a same SNPN reaches a maximum value, the UE 110 can still try the default UE credentials for onboarding services. Once the counter value reaches the maximum value, the UE 110 considers the default UE credentials invalid. In an example, a counter that is not SNPN-specific can be used for counting rejections from a same or different SNPNs. When a counter value reaches the maximum value, the UE 110 can consider the default UE credentials invalid.

In an example, for determining the default UE credentials as invalid for a specific SNPN (the default UE credentials can still be used for access to other onboarding networks), similarly, an SNPN-specific counter can be used. For example, before an account of times of receiving rejection messages from a same SNPN reaches a maximum value, an identity of the respective SNPN is not added to a forbidden onboarding SNPN list (temporary or permanent). Once the counter value reaches the maximum value, the respective SNPN is put onto the forbidden onboarding SNPN list. As a result, when a rejection is initially received from a current SNPN, the current SNPN is not put onto a forbidden onboarding SNPN list immediately. After several failed trials with the current SNPN, the current SNPN can be decided to be invalid for the default UE credentials and put onto the forbidden onboarding SNPN list. In case the UE 110 is under attack from one or more fake base stations, this SNPN-specific counter scheme can make it more difficult for the attack to be successful.

In some embodiments, the SNPN-specific counter scheme can be combined with the consideration of whether a reject message is received with integrity protection.

In an embodiment, for the UE 110 accessing the onboarding SNPN 120 for onboarding services, an SNPN-specific counter is used for counting a number of rejection messages without integrity protection or for which an integrity check is failed at the UE 110. For example, when a non-integrity protected rejection message or integrity-check-failed rejection message is received, the UE 110 can increment the value of the SNPN-specific counter. If the value of the SNPN-specific counter has not reached a maximum value, the UE 110 can continue to try the default UE credential for accessing the SNPN 120. If the value of the SNPN-specific counter has reached the maximum value, the UE 110 can consider the SNPN 120 is invalid for the default UE credentials and put the SNPN 120 onto a temporarily or permanently forbidden onboarding SNPN list. As the received reject message is not integrity protected or not successfully integrity checked, the UE 110 may not trust if the reject message is from an authentic or a fake base station, the UE 110 may take opportunities to try several times before putting the SNPN 120 onto the forbidden onboarding SNPN list.

While using the above SNPN-specific counter described in the last paragraph, the UE 110 may immediately put the SNPN 120 onto the forbidden onboarding SNPN list once an integrity-protected rejection message is received, even the value of the SNPN-specific counter has not reached the maximum value. As the UE 110 can trust an integrity-protected rejection message to be from an authentic base station or core network, the UE 110 can immediately determine the SNPN 120 is invalid for the default UE credentials.

Alternatively, instead of performing the increment of the SNPN-specific counter after a non-integrity protected reject message or an integrity-check-failed reject message is received, the UE 110 can increment the SNPN specific counter before a respective registration process or service request process is initiated. In either case, the SNPN-specific counter is used to count how many times the UE 110 has been denied or rejected by a reject message that is not integrity protected or unsuccessfully integrity checked.

Generally, the rejection handling methods disclosed herein provide mechanisms to prevent a UE from repeatedly accessing an SNPN that has denied the UE's request for onboarding services. As a result, resources of a network providing onboarding services can be saved from being used for handling those repeated requests.

While the rejection handling mechanisms are described herein in the context of SNPNs being employed for providing onboarding services, those rejection handling mechanisms are not limited to SNPNs. For example, when a public network (such as a PLMN) or a non-public network (NPN) sharing resources with a public network (such as a public network-integrated NPN (PNI-NPN)) is employed for onboarding services, the rejection handling methods disclosed herein can still be applied.

### III. Examples of Onboarding Rejection Handling

### Example 1

In an example, a UE supports onboarding services. A permanently forbidden SNPNs list for onboarding services and a temporarily forbidden SNPNs list for onboarding services are managed by the UE. The two lists for onboarding services can be used during a process for the selection of an onboarding network for access based on a set of default UE credentials.

In addition, the UE can be SNPN enabled and operate in SNPN access operation mode after receiving subscription information from a remote PVS during an onboarding process. The UE can manage a permanently forbidden SNPNs list and a temporarily forbidden SNPNs list. These lists can be used during a process of selection of an SNPN for access based on the remotely provisioned subscription information (including subscription credentials).

### Example 2

In an example, a UE can take the following actions depending on a cause value (such as a 5G mobile management (5GMM) cause value) received in a registration reject message: when the cause value is #3 (illegal UE) or #6 (illegal ME), if the UE is performing initial registration for onboarding services in an SNPN, the US can store an SNPN identity of the SNPN in a permanently forbidden SNPNs list for onboarding services.

### Example 3

In an example, a UE can take the following actions depending on a cause value (such as a 5G mobile management (5GMM) cause value) received in a service reject message: when the cause value is #3 (illegal UE) or #6 (illegal ME), if the UE is registered for onboarding services in an SNPN, the US can store an SNPN identity of the SNPN in a permanently forbidden SNPNs list for onboarding services.

### Example 4

In an example, a UE receives a 5GMM cause value of #7 (5GS services not allowed). If the UE is performing initial registration for onboarding services in an SNPN, the US can store an SNPN identity of the SNPN in a permanently forbidden SNPNs list for onboarding services.

### Example 5

In an example, a UE receives a 5GMM cause value of #7 (5GS services not allowed). If the UE is registered for onboarding services in an SNPN, the US can store an SNPN identity of the SNPN in a permanently forbidden SNPNs list for onboarding services.

### Example 6

In an example, a UE receives an EAP-failure message in an authentication reject message. If the authentication reject message has been successfully integrity checked by a NAS in the UE, if the UE is registered for onboarding services in an SNPN, or is performing an initial registration for onboarding services in the SNPN, the UE can store an SNPN identity of the SNPN in a permanently forbidden SNPNs list for onboarding services.

### Example 7

In an example, a UE receives an authentication reject message. In response, if the authentication reject message has been successfully integrity checked by a NAS in the UE, if the UE is registered for onboarding services in an SNPN, or is performing an initial registration for onboarding services in the SNPN, the UE can store an SNPN identity of the SNPN in a permanently forbidden SNPNs list for onboarding services.

### Example 8

In an example, an EA P-based primary authentication and key agreement process is used during an onboarding process of a UE in an SNPN. The UE can receive an EAP-failure message in an authentication reject message. The authentication reject message can be received without integrity protection. If the UE is registered for onboarding services in the SNPN or performing an initial registration for onboarding services in the SNPN, the UE can:

1) if an SNPN-specific attempt counter for the SNPN sending the authentication reject message has a value less than a maximum value, increment the SNPN-specific attempt counter for the SNPN; or

2) otherwise, the UE can store the SNPN identity of the SNPN in a permanently forbidden SNPNs list for onboarding services, and perform an SNPN selection process to select another onboarding SNPN for onboarding services.

### Example 9

In an example, a 5G AKA based primary authentication and key agreement process is used during an onboarding process of a UE in an SNPN. The UE can receive an authentication reject message without integrity protection. If the UE is registered for onboarding services in the SNPN or performing an initial registration for onboarding services in the SNPN, the UE can:

1) if an SNPN-specific attempt counter for the SNPN sending the authentication reject message has a value less than a maximum value, increment the SNPN-specific attempt counter for the SNPN; or

2) otherwise, the UE can store the SNPN identity of the SNPN in a permanently forbidden SNPNs list for onboarding services, and perform an SNPN selection process to select another onboarding SNPN for onboarding services.

### IV. UE Onboarding Rejection Handling Process

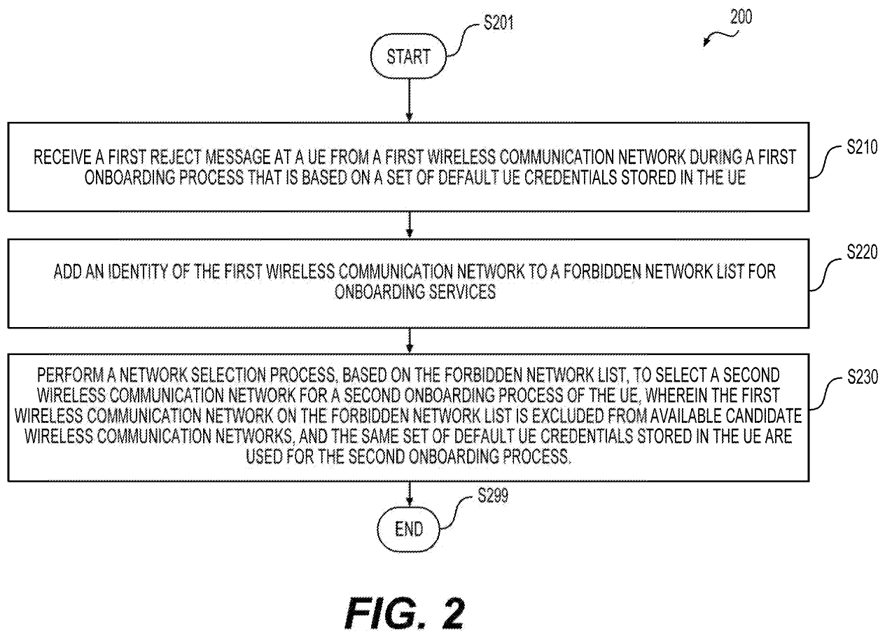

FIG. 2 shows an exemplary UE onboarding process 200 according to an embodiment of the disclosure. The UE 110 in the FIG. 1 example is used to explain the process 200. The process 200 can start from S201 and proceed to S210.

At S210, a first reject message can be received at the UE 110 from a first wireless communication network (such as the SNPN 120) that supports onboarding services during a first onboarding process of the UE. The first onboarding process can be based on the default UE credentials stored in the UE 110.

In an example, the first reject message can be a NAS authentication reject message containing an EAP failure message, for example, when an EAP-based mutual authentication and key agreement process is performed during the first onboarding process. In another example, the first reject message can be a NAS authentication reject message (not including an EAP failure message), for example, when a 5G AKA based mutual authentication and key agreement process is performed during the first onboarding process.

In an example, the first reject message can be a NAS registration reject message. The NAS registration reject message contains one of a cause value indicating an illegal UE, a cause value indicating an illegal ME, or a cause value indicating that 5GS services are not allowed. In another example, the first reject message can be a NAS service reject message. The first reject message contains one of a cause value indicating an illegal UE, a cause value indicating an illegal ME, or a cause value indicating that 5GS services are not allowed.

In various examples, the first wireless communication network and the second wireless communication network can be SNPNs, PNI-NPNs, or PLMNs that support onboarding services.

At S220, in response to the first reject message being received, an identity of the first wireless communication network can be added to a forbidden network list for onboarding services. In an example, the first reject message is successfully integrity checked by a NAS of the UE 110. The identity of the first wireless communication network is added to the forbidden network list for onboarding services no matter whether a network-specific attempt counter for the first wireless communication network has a value equal to or less than a maximum value.

In another example, the first reject message is not successfully integrity checked by the NAS of the UE 110 or not integrity protected. In response, if the network-specific attempt counter for the first wireless communication network has a value equal to the maximum value, the identity of the first wireless communication network can be added to the forbidden network list for onboarding services.

In the above example, a second reject message can be received before the first reject message being received without integrity protection. The second reject message can be received without integrity protection or unsuccessfully integrity checked. The network-specific attempt counter for the first wireless communication network has a value less than the maximum value. In such a scenario, the network-specific attempt counter for the first wireless communication network can be incremented, and the UE 110 can have another try to access the first wireless network for onboarding services.

In an example, the forbidden network list for onboarding services is a permanently forbidden SNPN list for onboarding services. In another example, the forbidden network list for onboarding services is a temporarily forbidden SNPN list for onboarding services.

At S230, the UE 110 can perform a network selection process to select a second wireless communication network for a second onboarding process of the UE. The selection can be based on the forbidden network list including the identity of the first wireless communication network. The second wireless network can be selected among available candidate wireless communication networks that support onboarding services. The first wireless communication network on the forbidden network list is excluded from the available candidate wireless communication networks that support onboarding services. The same set of default UE credentials stored in the UE are used for the second onboarding process of the UE towards the second wireless network. The process 200 can proceed to S299 and terminate at S299.

### V. Apparatus

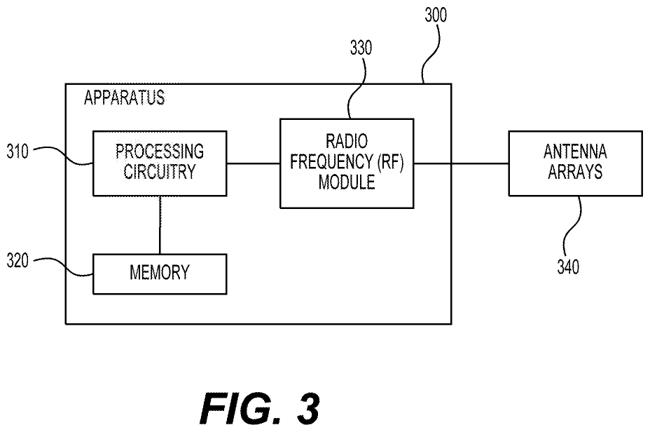

FIG. 3 shows an exemplary apparatus 300 according to embodiments of the disclosure. The apparatus 300 can be configured to perform various functions in accordance with one or more embodiments or examples described herein. Thus, the apparatus 300 can provide means for implementation of mechanisms, techniques, processes, functions, components, systems described herein. For example, the apparatus 300 can be used to implement functions of UEs, base stations, core network, and servers in various embodiments and examples described herein. The apparatus 300 can include a general-purpose processor or specially designed circuits to implement various functions, components, or processes described herein in various embodiments. The apparatus 300 can include processing circuitry 310, a memory 320, and a radio frequency (RF) module 330.

In various examples, the processing circuitry 310 can include circuitry configured to perform the functions and processes described herein in combination with software or without software. In various examples, the processing circuitry 310 can be a digital signal processor (DSP), an application-specific integrated circuit (ASIC), programmable logic devices (PLDs), field-programmable gate arrays (FPGAs), digitally enhanced circuits, or comparable device or a combination thereof.

In some other examples, the processing circuitry 310 can be a central processing unit (CPU) configured to execute program instructions to perform various functions and processes described herein. Accordingly, the memory 320 can be configured to store program instructions. The processing circuitry 310, when executing the program instructions, can perform the functions and processes. The memory 320 can further store other programs or data, such as operating systems, application programs, and the like. The memory 320 can include non-transitory storage media, such as a read-only memory (ROM), a random access memory (RAM), a flash memory, a solid-state memory, a hard disk drive, an optical disk drive, and the like.

In an embodiment, the RF module 330 receives a processed data signal from the processing circuitry 310 and converts the data signal to beamforming wireless signals that are then transmitted via antenna arrays 340, or vice versa. The RF module 330 can include a digital to analog converter (DAC), an analog to digital converter (ADC), a frequency upconverter, a frequency down converter, filters and amplifiers for reception and transmission operations. The RF module 330 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 340 can include one or more antenna arrays.

The apparatus 300 can optionally include other components, such as input and output devices, additional or signal processing circuitry, and the like. Accordingly, the apparatus 300 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through a physical medium or distributed system, including, for example, from a server connected to the Internet.

The computer program may be accessible from a computer-readable medium providing program instructions for use by or in connection with a computer or any instruction execution system. The computer-readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random access memory (RAM), a read-only memory (ROM), a magnetic disk and an optical disk, and the like. The computer-readable non-transitory storage medium can include all types of computer-readable medium, including magnetic storage medium, optical storage medium, flash medium, and solid-state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
receiving a first reject message at a user equipment (UE) from a first wireless communication network that supports onboarding services during a first onboarding process of the UE towards the first wireless communication network based on a set of default UE credentials stored in the UE;
in response to the first reject message being received, adding an identity of the first wireless communication network to a forbidden network list for onboarding services, and
performing, by the UE, a network selection process, based on the forbidden network list including the identity of the first wireless communication network, to select a second wireless communication network for a second onboarding process of the UE among available candidate wireless communication networks that support onboarding services, wherein
the first wireless communication network on the forbidden network list is excluded from the available candidate wireless communication networks that support onboarding services, and the same set of default UE credentials stored in the UE are used for the second onboarding process of the UE towards the second wireless communication network.

2. The method of claim 1, wherein the first wireless communication network and the second wireless communication network are each a stand-alone non-public network (SNPN), and the forbidden network list for onboarding services is a permanently forbidden SNPN list for onboarding services.

3. The method of claim 1, wherein the first reject message is a non-access-stratum (NAS) authentication reject message containing an extensible authentication protocol (EAP) failure message.

4. The method of claim 1, wherein the first reject message is a NAS authentication reject message.

5. The method of claim 1, wherein the first reject message is a NAS registration reject message containing one of:
a cause value indicating an illegal UE,
a cause value indicating an illegal mobile equipment (ME), or
a cause value indicating that fifth-generation system (5GS) services are not allowed.

6. The method of claim 1, wherein the first reject message is a NAS service reject message containing one of:
a cause value indicating an illegal UE,
a cause value indicating an illegal ME, or
a cause value indicating that 5GS services are not allowed.

7. The method of claim 1, wherein the first reject message is successfully integrity checked by a NAS of the UE.

8. The method of claim 1, wherein the adding include:
in response to the first reject message being received without integrity protection or failing integrity protection check and a network-specific attempt counter for the first wireless communication network that is an SNPN having a value equal to a maximum value, adding the identity of the first wireless communication network to the forbidden network list for onboarding services.

9. The method of claim 8, further comprising:
in response to a second reject message being received without integrity protection or failing integrity protection check before the first reject message being received without integrity protection or failing integrity protection check and the network-specific attempt counter for the first wireless communication network that is an SNPN having a value less than the maximum value, incrementing the network-specific attempt counter for the first wireless communication network that is the SNPN.

10. An apparatus, comprising circuitry configured to:
receive a first reject message at a user equipment (UE) from a first wireless communication network that supports onboarding services during a first onboarding process of the UE towards the first wireless communication network based on a set of default UE credentials stored in the UE;
in response to the first reject message being received, add an identity of the first wireless communication network to a forbidden network list for onboarding services; and
perform, by the UE, a network selection process, based on the forbidden network list including the identity of the first wireless communication network, to select a second wireless communication network for a second onboarding process of the UE among available candidate wireless communication networks that support onboarding services, wherein
the first wireless communication network on the forbidden network list is excluded from the available candidate wireless communication networks that support onboarding services, and the same set of default UE credentials stored in the UE are used for the second onboarding process of the UE towards the second wireless communication network.

11. The apparatus of claim 10, wherein the first wireless communication network and the second wireless communication network are each a stand-alone non-public network (SNPN), and the forbidden network list for onboarding services is a permanently forbidden SNPN list for onboarding services.

12. The apparatus of claim 10, wherein the first reject message is a non-access-stratum (NAS) authentication reject message containing an extensible authentication protocol (EAP) failure message.

13. The apparatus of claim 10, wherein the first reject message is a NAS authentication reject message.

14. The apparatus of claim 10, wherein the first reject message is a NAS registration reject message containing one of:
a cause value indicating an illegal UE,
a cause value indicating an illegal mobile equipment (ME), or
a cause value indicating that fifth-generation system (5GS) services are not allowed.

15. The apparatus of claim 10, wherein the first reject message is a NAS service reject message containing one of:
a cause value indicating an illegal UE,
a cause value indicating an illegal ME, or
a cause value indicating that 5GS services are not allowed.

16. The apparatus of claim 10, wherein the first reject message is successfully integrity checked by a NAS of the UE.

17. The apparatus of claim 10, wherein the circuitry is further configured to:
in response to the first reject message being received without integrity protection or failing integrity protection check and a network-specific attempt counter for the first wireless communication network that is an SNPN having a value equal to a maximum value, add the identity of the first wireless communication network to the forbidden network list for onboarding services.

18. The apparatus of claim 17, wherein the circuitry is further configured to:
in response to a second reject message being received without integrity protection or failing integrity protection check before the first reject message being received without integrity protection or failing integrity protection check and the network-specific attempt counter for the first wireless communication network that is an SNPN having a value less than the maximum value, increment the network-specific attempt counter for the first wireless communication network that is the SNPN.

19. A non-transitory computer-readable medium storing instructions that, when executed by a processor, cause the process to perform a method, the method comprising:
receiving a first reject message at a user equipment (UE) from a first wireless communication network that supports onboarding services during a first onboarding process of the UE towards the first wireless communication network based on a set of default UE credentials stored in the UE;
in response to the first reject message being received, adding an identity of the first wireless communication network to a forbidden network list for onboarding services; and
performing, by the UE, a network selection process, based on the forbidden network list including the identity of the first wireless communication network, to select a second wireless communication network for a second onboarding process of the UE among available candidate wireless communication networks that support onboarding services, wherein
the first wireless communication network on the forbidden network list is excluded from the available candidate wireless communication networks that support onboarding services, and the same set of default UE credentials stored in the UE are used for the second onboarding process of the UE towards the second wireless communication network.

20. The non-transitory computer-readable medium, wherein the first wireless communication network and the second wireless communication network are each a stand-alone non-public network (SNPN), and the forbidden network list for onboarding services is a permanently forbidden SNPN list for onboarding services.
